(19) United States
(12) Patent Application Publication
(10) Pub. No.: US 2006/0072278 A1
(43) Pub. Date: Apr. 6, 2006

(54) Apparatus for manufacturing particles using corona discharge and method thereof

(76) Inventors: Kang-Ho Ahn, SEOUL (KR); Jeong-Ho Ahn, Seoul (KR); Sang-Hyun Ahn, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/534,585

(22) PCT Filed: Nov. 12, 2002
(86) PCT No.: PCT/KR02/02113

§ 371 Date: May 11, 2005

(51) Int. Cl. H02H 1/04

(52) U.S. Cl. 361/212

(57) ABSTRACT

An apparatus and method for manufacturing particles using corona discharge is disclosed. A discharge electrode is provided within a guide duct and reaction gases are supplied into the guide duct. A high voltage is applied to the discharge electrode and a low voltage is applied to the guide duct to generate a voltage difference therebetween. When heat energy is applied to the reaction gases, chemical reactions occur in the gases and particles are made by the chemical reactions. The particles form new particles centering around ions as nuclei which are generated by corona discharge and moves along the guide duct. A collecting plate positioned in front of the guide duct collects the particles.

### TECHNICAL FIELD

The present invention relates to an apparatus and method for manufacturing particles, and more particularly, to an apparatus and method for manufacturing particles using corona discharge.

### BACKGROUND ART

Generally, particles are manufactured by a method of collecting them through a filter or sticking them to a collecting plate after they have been formed by using flames or a furnace. According to this method, metal oxide such as SiO₂ or Fe₂O₃ having ultrahigh purity are obtained.

However, in conventional methods for manufacturing the particles, there are some disadvantages in that their collecting efficiency is very low, and in that sizes of the collected the particles cannot be controlled. In addition, there are problems in that most of the particles that are not collected cannot be recovered, and in that since the particles that have been recovered are mainly metal oxide, they may contaminate the environment. Especially, in the conventional method for manufacturing the particles by using the filter, there is a trouble in that the filter should be frequently replaced due to serious contamination of the filter.

### DISCLOSURE OF INVENTION

An object of the present invention is to provide an apparatus and method for manufacturing particles using corona discharge, in which very high collecting efficiency can be obtained.

Another object of the present invention is to provide an apparatus and method for manufacturing particles using corona discharge, in which sizes of the particles can be controlled.

In order to achieve the above objects, according to an aspect of the present invention, there is provided an apparatus for manufacturing particles using corona discharge comprising a guide duct; a discharging device of which a discharge electrode is positioned within the guide duct, and which generate ions through electric discharge; a reaction gas supplying device for supplying reaction gases into the guide duct; a voltage applying device connected to the discharging device and the guide duct so as to generate voltage difference therebetween; a heating device which is disposed on an outer surface of the guide duct for applying energy to the reaction gases so as to generate particles which are adhered to the ions generated by the discharging device; a collecting device disposed to be spaced apart from outlet of the guide duct by a predetermined distance for collecting the particles.

According to another aspect of the present invention, there is also provided an apparatus for manufacturing particles using corona discharge, comprising a first guide duct; a second guide duct positioned at an outer side of the first guide duct and having an axis coaxial with the first guide duct; a fourth guide duct positioned at an outer side of said second guide duct and having an axis coaxial with the said second guide duct; a discharging device of which discharge electrode is positioned within the first guide duct, and which generate ions through electric discharge; a reaction control gas supplying device which supplies reaction control gases into the first guide duct so as to generate a lot of ions from the discharging device and to prevent chemical reaction from occurring around the discharge electrode; a reaction gas supplying device for supplying reacting gases into the second guide duct; a fuel gas supplying device for supplying fuel gases into the fourth guide duct; a voltage applying device connected to the discharging device and the first guide duct so as to generate voltage difference therebetween; a collecting device disposed to be spaced apart from outlet of the guide ducts by predetermined distance for collecting the particles of reaction gases adhered to the ions.

According to a further aspect of the present invention, there is provided a method for manufacturing particles using corona discharge, comprising the steps of preparing an apparatus for manufacturing particles using corona discharge comprising a guide duct with a discharge electrode positioned therein, a voltage applying device connected to the discharge electrode and to the guide duct, and a collecting device for collecting the particles; applying high voltage to the discharge electrode and applying low voltage to the guide duct, while generating ions through the discharge electrode and guiding the generated ions along the guide duct; supplying reaction gases into the guide duct; applying energy to the reaction gases to generate particles which are adhered to the ions; collecting the particles adhered to the ions by the collecting device positioned in front of the guide duct.

### BRIEF DESCRIPTION OF THE DRAWINGS

FIG. 1 is a sectional view showing a first embodiment of an apparatus for manufacturing particles according to the present invention,

FIG. 2 is a sectional view showing a first modification of the first embodiment shown in FIG. 1,

FIG. 3 is a sectional view showing a second modification of the first embodiment shown in FIG. 1,

FIG. 4 is a sectional view showing a third modification of the first embodiment shown in FIG. 1,

FIG. 5 is a sectional view showing a fourth modification of the first embodiment shown in FIG. 1,

FIG. 6 is a sectional view showing a second embodiment of an apparatus for manufacturing particles according to the present invention,

FIG. 7a is a sectional view showing a third embodiment of an apparatus for manufacturing particles according to the present invention,

FIG. 7b is a perspective view of the guide duct shown in FIG. 7a,

FIG. 8 is a sectional view showing a first modification of the third embodiment shown in FIG. 7,

FIG. 9 is a sectional view showing a second modification of the third embodiment shown in FIG. 7,

FIG. 10 is a sectional view showing a fourth embodiment of an apparatus for manufacturing particles according to the present invention,

FIG. 11 is a sectional view showing a first modification of the fourth embodiment shown in FIG. 7,

FIG. 12 is a sectional view showing a second modification of the fourth embodiment shown in FIG. 7,

FIG. 13 is a sectional view showing a fifth embodiment of an apparatus for manufacturing particles according to the present invention,

FIG. 14 is a sectional view showing a sixth embodiment of an apparatus for manufacturing particles according to the present invention,

FIG. 15 is a flow chart showing a method for manufacturing particles according to the present invention.

### BEST MODE FOR CARRYING OUT THE INVENTION

Hereinafter, embodiments of an apparatus and method for manufacturing particles using corona discharge according to the present invention will be explained in detail with reference to the accompanying drawings.

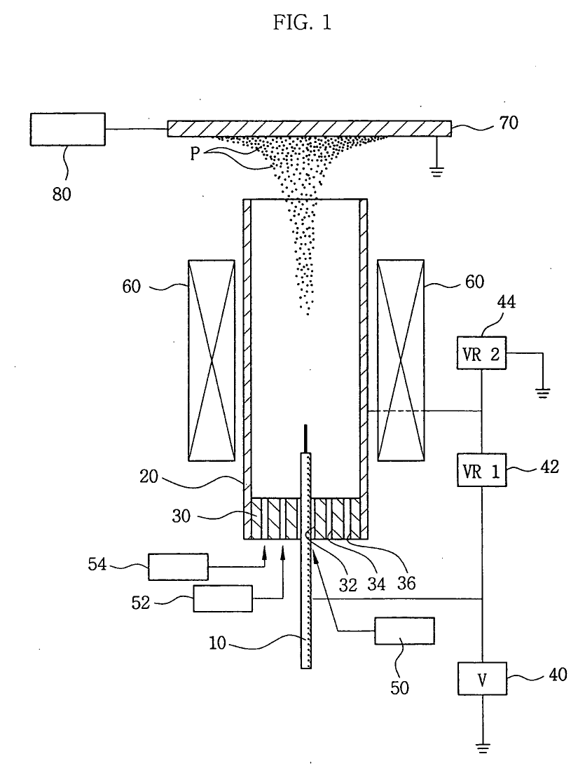

First, the constitution of a first embodiment of an apparatus for manufacturing particles according to the present invention will be explained with reference to FIG. 1. Referring to FIG. 1, a needle type discharge electrode 10 is positioned within a guide duct 20. As well known, when a high voltage is applied to the discharge electrode 10, a lot of ions are generated around the discharge electrode 10 by the corona discharge as electric discharge. In order to prevent the ions generated by corona discharge from adhering to an inside wall of the guide duct 20, a voltage is applied to the guide duct 20 to have the same polarity as the voltage applied to the discharge electrode 10.

Thus, a high voltage is applied to the discharge electrode 10 from a power supply 40, while a low voltage having the same polarity as the voltage applied to the discharge electrode 10 is applied to the guide duct 20. In order to generate a voltage difference between the discharge electrode 10 and the guide duct 20, a first variable resistor 42 drops a high voltage form the power supply 40. In addition, a second variable resistor 44 is connected to the first variable resistor 42 so as to further drop the voltage dropped by the first variable resistor 42, and is connected to ground. If the first and second variable resistors 42, 44 have the equal voltage level, a voltage applied between the discharge electrode 10 and the guide duct 20 becomes the same as a voltage applied between the guide duct 20 and the ground. In the present embodiment, although the variable resistors 42, 44 are used for generating the voltage difference between the discharge electrode 10 and the guide duct 20, they may replaced with fixed resistors. In addition, instead of the single power supply 40 and two variable resistors 42, 44, two power supplies may be used so that a high voltage can be applied to the discharge electrode and a low voltage can be applied to the guide duct 20.

A supporting member 30 is fitted into the guide duct 20. The discharge electrode 10 is installed to pass through the supporting member 30, and the supporting member 30 has throughholes 32, 34, 36 adapted to communicate with the interior of the guide duct 20. In order to assist in generating a lot of ions and prevent chemical reaction from occurring by strong energy around the region where the corona is generated, reaction control gases such as CO₂ or N₂ are supplied by a reaction control gas supplying means 50 through the central throughhole 32. Oxidation gases capable of generating chemical reaction such as O₂ or H₂ are supplied by an oxidation gas supplying device 52 through the throughhole 34. Reaction gases such as SiCl₂ or GeCl₄ which move with carrier gases such as N₂ or Ar are supplied by reaction gas supply device 54 through the throughhole 36. In the present embodiment, although the oxidation gases and the reaction gases are supplied through the the throughholes 34, 36, respectively, the oxidation gases and the reaction gases are mixed and supplied through the one throughhole. Since well-known devices are adaptable to the reaction control gas supplying device 50, the oxidation gas supplying device 52 and reaction gas supplying device, detailed descriptions related thereto will be omitted herein.

A heater 60 for heating the guide duct 20 and applying energy to the reaction gas which can generate particles is installed around an outer surface of the guide duct 20. A conventional heat generator using resistance wires is used as the heater 60, and a device capable of applying the energy to the guide duct 20, such as an infrared lamp or an ultraviolet lamp, may be used.

A collecting plate 70 is disposed to be spaced apart from the guide duct 20 by a predetermined distance in front of the outlet of the guide duct 20. The collecting plate 70 is electrically grounded, and a cooler 80 for cooling the collecting plate 70 is connected to the collecting plate 70 so as to increase its collecting efficiency. The cooling of the collecting plate 70 is carried out by the conventional cooler 80 capable of injecting cold substances into the collecting plate 70 or maintaining the collecting plate 70 at a low temperature. FIG. 1 shows the collecting plate 70 as a colleting means. However instead of the colleting plate 70, a hollow collecting tube that is coaxially aligned with the guide duct 20 may be employed. In addition, although the colleting plate connected to the cooling device is employed in the present embodiment, other collecting device capable of collecting the particles such as a filter are adaptable instead of the collecting plate.

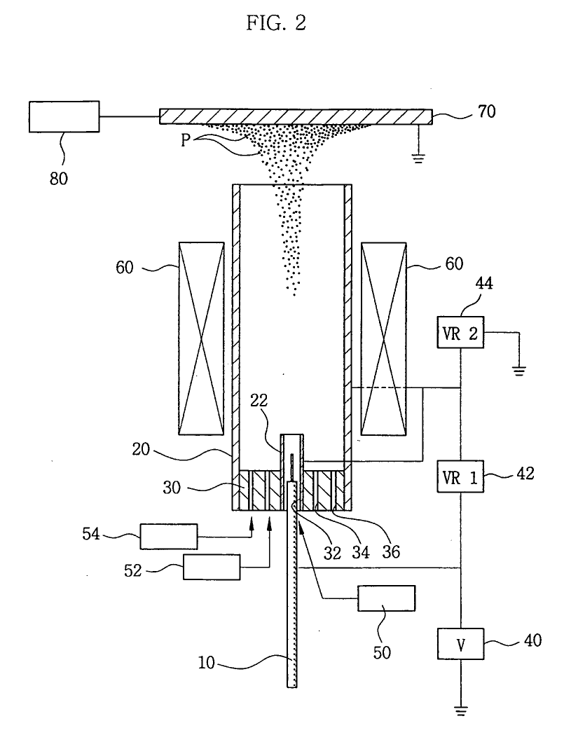

FIG. 2 represents a first modification of the first embodiment of FIG. 1. The basic configuration of the first modification is same as that of the first embodiment. As shown in FIG. 2, the first modification further comprises a guide electrode 22 surrounding the discharge electrode 10 so as to induce a laminar flow of the ions. The ions are generated from discharge electrode 10, where a high voltage is applied. In the present modification, the voltage applied to the guide electrode 22 is same as the voltage applied to the guide duct 20. A voltage dropped by the first variable resistor 42 is applied to the guide electrode 22. Thus, the guide electrode 22 has the same polarity but has lower voltage level than the discharge electrode 10.

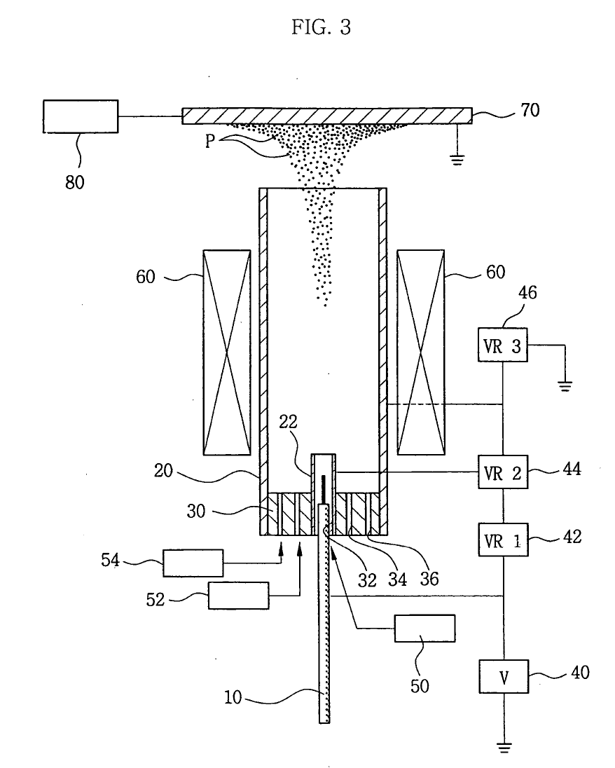

FIG. 3 represents a second modification of the first embodiment. In the present modification as shown in FIG. 3, the guide electrode 22 maintain a voltage level lower than that of the corona discharge electrode 10 and higher than the voltage level of the guide duct 20.

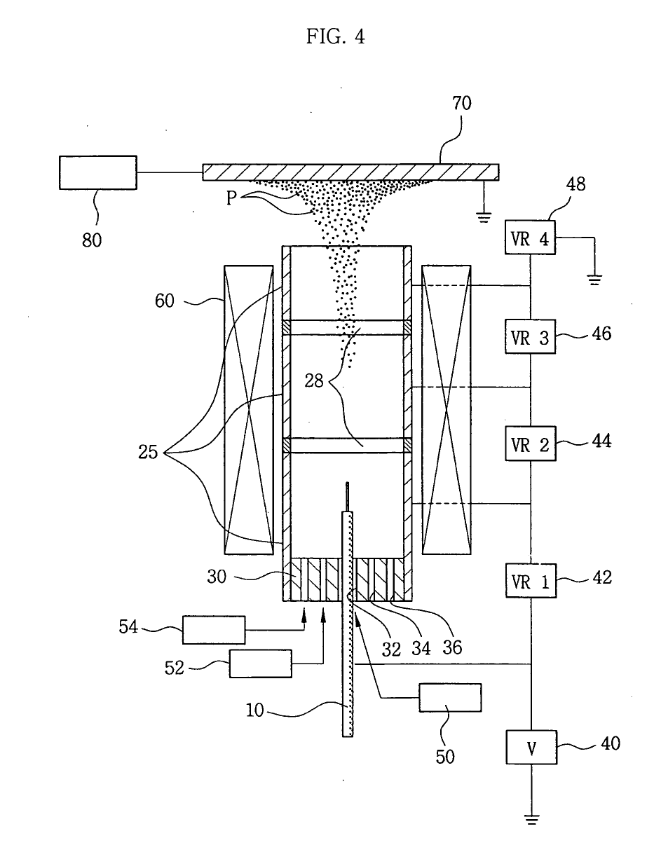

FIG. 4 represents a third modification of the first embodiment. The third modification of the first embodiment is constructed by continuously combining a plurality of mutually connected guide ducts 25, instead of the guide duct 20 shown in FIG. 1. The number of the connected guide ducts 25 is three in the present modification. Insulating materials 27 are interposed between the guide ducts 25 adjacent to each other so as to electrically insulate the adjacent guide ducts 25. Voltages are distributed and adapted to each of the guide ducts 25 by means of the first, second, third and forth variable resistors 42, 44, 46, 48. Accordingly, the electric field gradient is generated within the guide ducts 20. At this time, since the gradient of the electric field within the entire guide ducts 20 becomes larger than that within the guide duct 20 of the first embodiment, the discharged ions move more quickly.

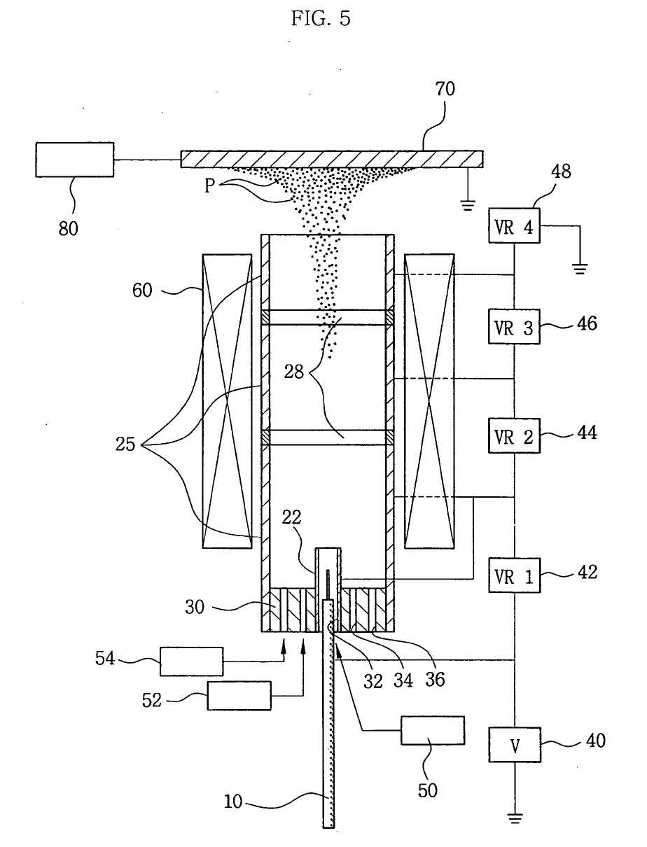

FIG. 5 represents a fourth modification of the first embodiment. The basic configurations of the first modification and the first embodiment are the same. The fourth modification has guide electrode 22 as shown in the first modification, and the voltage dropped by the first variable resistor 42 is applied to the guide electrode 22.

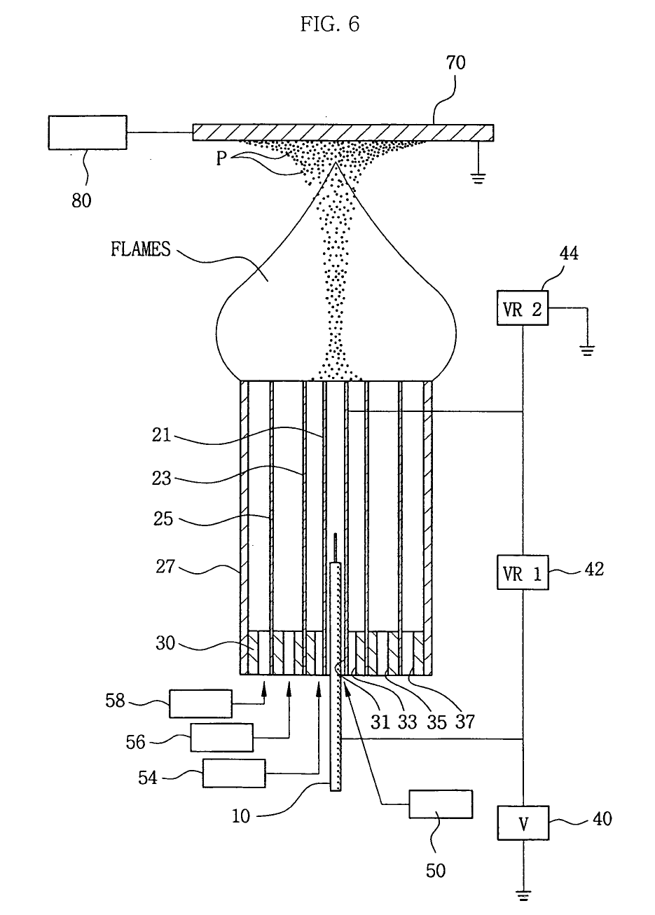

Next, the constitution of a second embodiment of an apparatus for manufacturing particles according to the present invention will be explained. The second embodiment uses flames instead of the heating means 60 of the first embodiment. Referring to FIG. 6, similarly to the first embodiment shown in FIG. 1, the discharge electrode 10 is positioned within a first guide duct 21. With the same power supply 40, first variable resistor 42 and second variable resistor 44 as the constitution shown in FIG. 1, a high voltage is applied to the discharge electrode 10 while a low voltage is applied to the first guide duct 21.

Meanwhile, a second guide duct 23 having an axis coaxial with that of the first guide duct 21 is disposed at outer side of the first guide duct 21, a third guide duct 25 having an axis coaxial with that of the second guide duct 23 is disposed at outer of the second guide duct 23, and a fourth guide duct 27 is disposed at outer of the third guide duct 25. A supporting member 30 is fitted into the first, second, third and fourth guide ducts 21, 23, 25, 27, and the discharge electrode 10 is installed to pass through the supporting member 30. In the supporting member 30, a first throughhole 31, a second throughhole 33, a third throughhole 35 and a fourth throughhole 37 are formed to communicate with the first guide duct 21, the second guide duct 23, the third guide duct 25 and the fourth guide duct 27, respectively.

Through the first throughhole 31, similarly to the first embodiment, a chemical reaction control gas supplying device 54 supplies chemical reaction control gases so as to assist in generating a lot of ions from the discharge electrode 10 and to prevent chemical reaction from occurring by the strong energy around the discharge electrode. Through the second throughhole 33, a reaction gas supplying device 54 supplies reaction gases such as SiCl₄ or GeCl₄. Through the third throughhole 35, a sheath gas supplying device supplies sheath gases and through the fourth throughhole 37, fuel gas supplying device 58 supplies fuel gases. The sheath gases prevent heat of flames from being transferred to the first guide duct 21 when the flames occur at the end of the fourth guide duct 27 by means of ignition of the supplied fuel gases. At the same time, the sheath gases prevent the reaction gases discharged from the interior of the second guide duct 23 from chemically reacting at the end of the second guide duct 23.

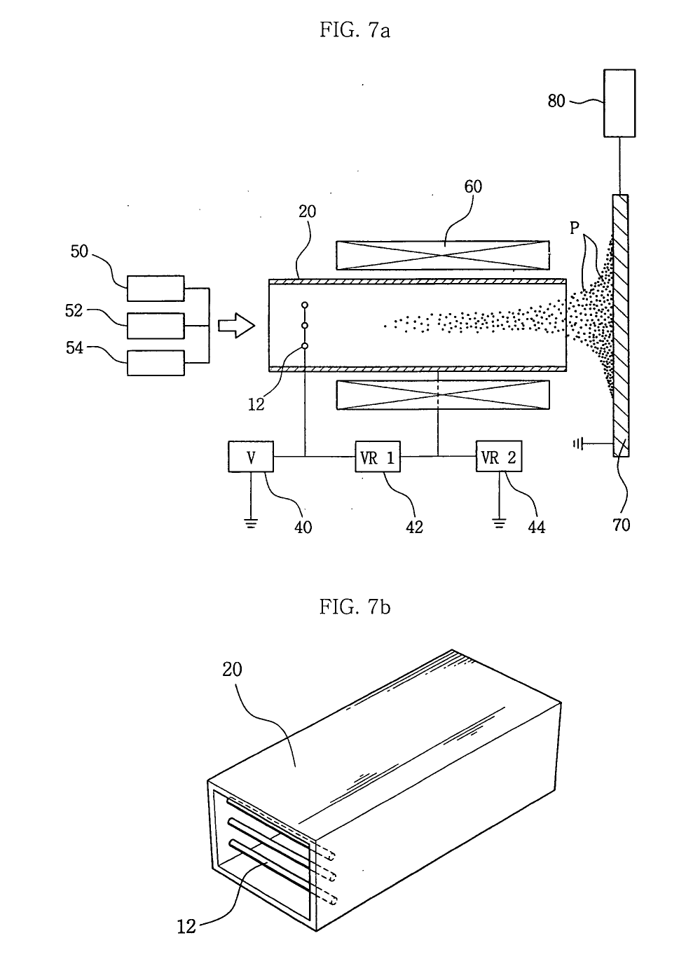

Next, the constitution of a third embodiment of an apparatus for manufacturing particles according to the present invention will be explained. Referring to FIG. 7a and FIG. 7b, the third embodiment has a wire type discharge electrode 12 in stead of the needle type discharge electrode used in the above mentioned embodiments. The section of the wire type discharge electrode 12 may have various configurations such as a round shape, a rectangular shape or lozenge shape. The wire type discharge electrode 12 is installed transversely in the guide duct 20, while, similarly to the above mentioned embodiments, a voltage higher than that of the guide duct 20 is applied to the discharge electrode 12. According to the aforementioned constitution of the third embodiment, the wire type discharge electrode 12 has an advantage of manufacturing a large quantity of particles by means of generating ions much more than those generated from needle type discharge electrode 10. The both ends of the wire type discharge electrode 12 and the guide duct 20 are insulated electrically therebetween.

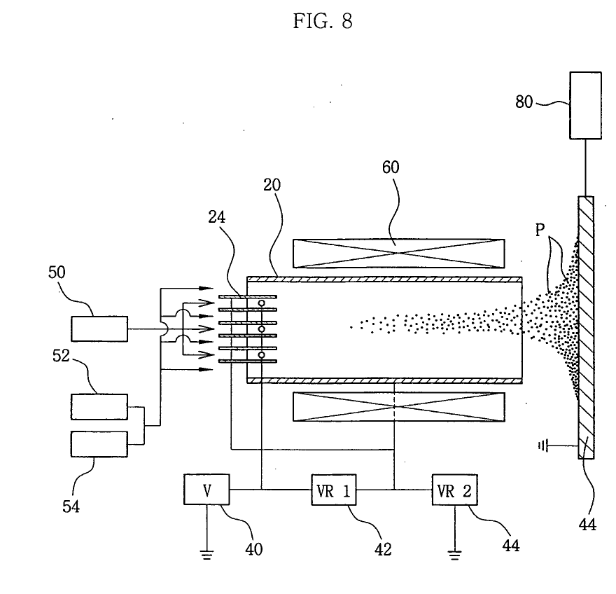

FIG. 8 represents a first modification of the third embodiment. In order to increase the generation of ions by means of corona discharge around the wire type discharge electrode 12 and to prevent dust substances from adhering to the wire type discharge electrode 12, the present modification includes a guide plate 24 surrounding the discharge electrode 12 so that chemical reaction gases such as CO₂ or N₂ are supplied by a chemical reaction gas supplying device. In addition, a voltage which has the same polarity and level as the guide duct 20 is applied to the guide plate 24, so that the guide plate 24 guides the flow of the ions generated from the discharge electrode 12 by means of the corona discharge. Meanwhile, oxidation gases or reaction gases or the mixed oxidation gases and reaction gases are supplied between the guide plates 24 by an oxidation gas supplying device 52 or a reaction gas supplying device 54.

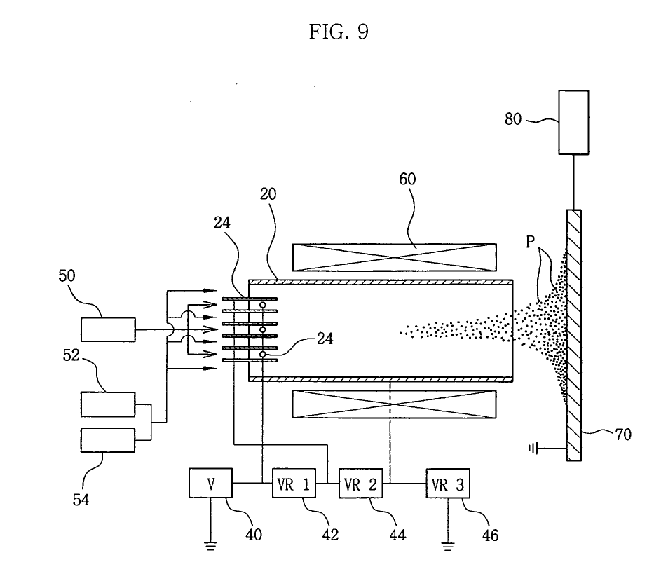

FIG. 9 represents a second modification of the third embodiment. In the second modification as shown in FIG. 3, similarly to the second modification of the first embodiment, the guide plate 24 maintain a voltage lower than that of the discharge electrode 12 and higher than that of the guide duct 20 by connecting a third variable resistor 46.

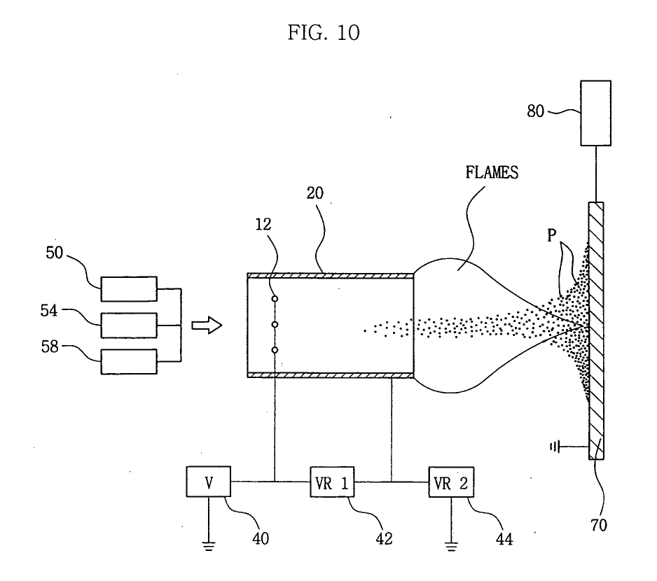

Next, the constitution of a fourth embodiment of an apparatus for manufacturing particles according to the present invention will be explained. Referring to the FIG. 10, the present embodiment is similar to the third embodiment in basic configuration, and uses the flames instead of the heating means 60 similarly to the second embodiment.

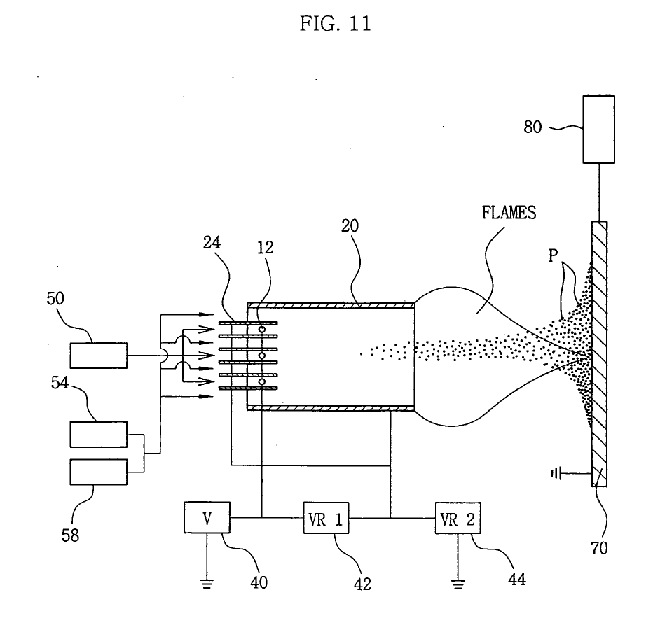

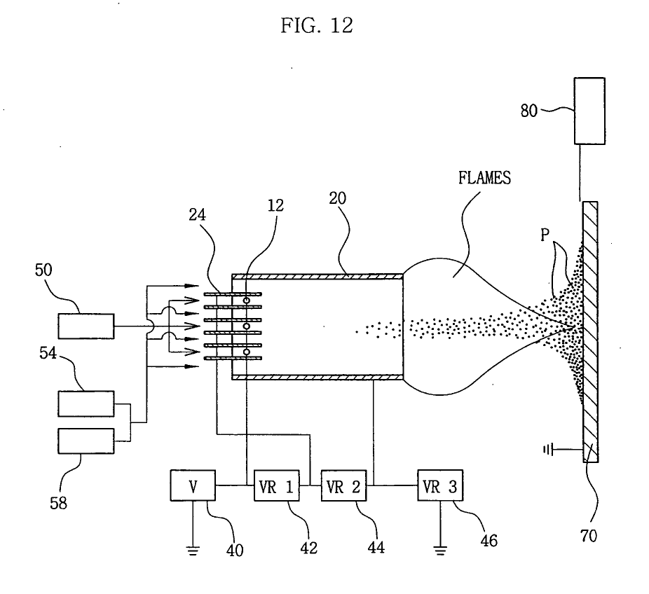

FIG. 11 represents a first modification of the fourth embodiment, and FIG. 12 represents a second modification of the fourth embodiment. Each of the first and the second modification is an apparatus for manufacturing particles using flames, each of the modifications adopts the basic constitution of the aforementioned first and second modification of the third embodiment, respectively.

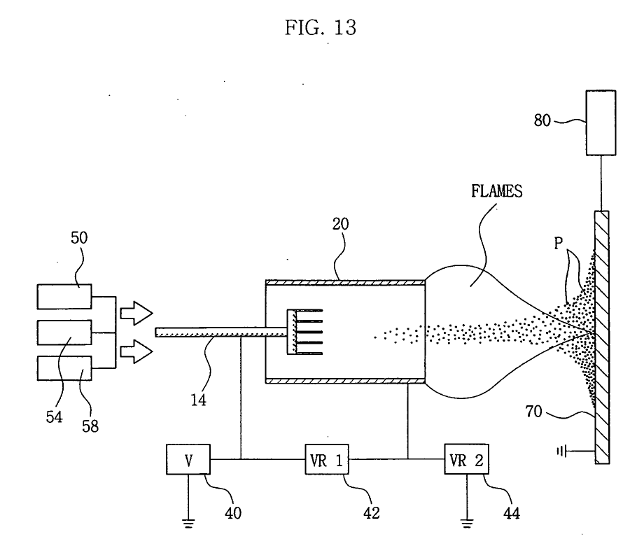

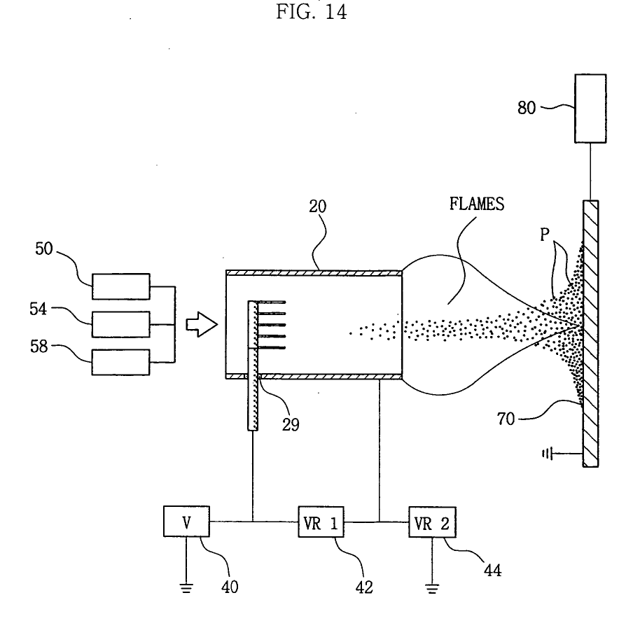

FIG. 13 and FIG. 14 represent a fifth embodiment and a sixth embodiment of an apparatus for manufacturing particles according to the present invention. In the fifth embodiment, a plurality of needle type discharge electrodes 14 are disposed at T-type electrode. In the sixth embodiment, a plurality of discharge electrodes 14 are installed at a linear type electrode penetrating through the outer wall of the guide duct 20. An insulator 29 is interposed between the outer wall of the guide dust 20 and the linear type discharge electrode 14.

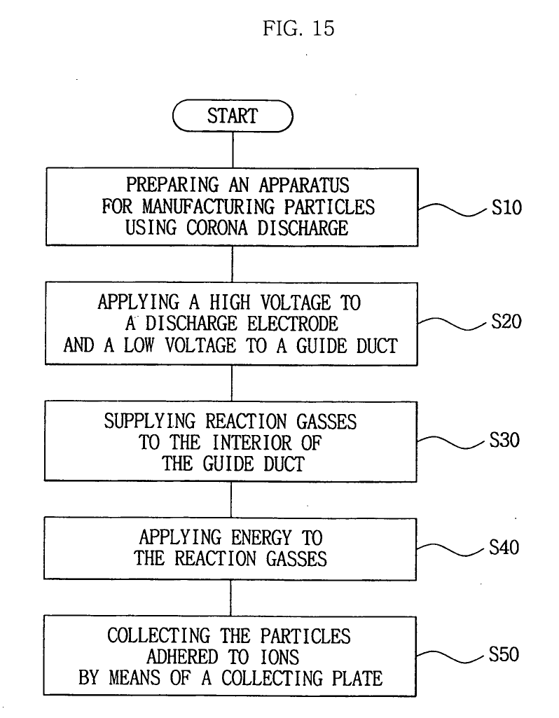

Now, a method for manufacturing particles using corona discharge according to the present invention will be explained with reference to FIG. 15. Since the effects of the above mentioned other embodiments and modifications are basically same as but partially different from that of the first embodiment or the second embodiment, the method for manufacturing particles using corona discharge according to the constitutions of the first embodiment and the second embodiment of the apparatuses of present invention will be explained hereinafter.

First, the apparatus for manufacturing particles using corona discharge comprising the guide duct 20;21 wherein the discharge electrode 10 is positioned, the power supply 40 which is applied to the discharge electrode 10 and the guide duct 20;21 and the variable resistors 42, 44 which are connected to the guide duct 20;21 as the voltage applying device, and the collecting plate 70 for collecting the particles are prepared (S10). After preparing the apparatus for manufacturing particles having the mentioned elements, the different voltages are applied to the discharge electrode 10 and the guide duct 20 or the first guide duct 21, respectively (S20). Then, since a high voltage is applied to the discharge electrode 10 by means of the power supply 40 having high voltage level and a low voltage is applied to the guide duct 20 or the first guide duct 21, a lot of ions are generated from the discharge electrode 10 by means of the corona discharge as an electric discharge. Meanwhile, according to configuration of the first embodiment, the reaction gases are supplied to the interior of the guide duct 20 (S30). The generated ions move to the down stream of the guide duct 20 along the flow of the reaction gases supplied through the throughholes 32, 34, 36. At this time, since the voltage having the same polarity as that of the voltage applied to the discharge electrode 10 is applied to the guide duct 20, the ions generated from the discharge electrode 10 are not attached to the guide duct 20.

According to the configuration of the first embodiment, since the guide duct 20 is heated by the heater 60, the interior of the guide duct 20 goes into a high temperature state. Accordingly, the reacting gases reach a high temperature region and react chemically at the high temperature region (S40). As these chemical reactions occur, metallic or non-metallic particles are formed. By using ions distributed around the particles as nuclei, new particles P are formed. Therefore, these particles thus formed are naturally charged and quickly discharged to the outside of the guide duct 20 by the electric field gradient existing in the interior of the guide duct 20 and their flow steam. At this time, since these particles have the same polarity, the particles do not adhere to each other.

Next, since the collecting plate 70 is positioned in front of the outlet of the guide duct 20, the metallic or non-metallic particles formed through the chemical reactions at the high temperature region of the guide duct 20 as described above move to the outside of the guide duct 20 and continuously adhere to the collecting plate 70 (S50). At this time, since the particles have the same polarity, the particles do not adhere to each other, but adhere to the collecting plate 70. In addition, since the collecting plate 70 is cooled by the cooler 80, the particles efficiently adhere to the collecting plate 70. As described above, the particles discharged from the guide duct 20 very efficiently adhere to the colleting plate 70 through two physical phenomena, i.e., electric field and thermophoresis.

According to the constitution of the second embodiment, in order to assist in generating a lot of ions from the discharge electrode 10 and to prevent chemical reaction from occurring by the strong energy around the discharge electrode 10, the chemical reaction control gases such as CO₂ or N₂ are supplied to the interior of the first guide duct 21. The reaction gases such as SiCl₄ or GeCl₄ are supplied between the first guide duct 21 and the second guide duct 23 (S30), and the sheath gases are supplied between the second guide duct 23 and the third guide duct 25. The fuel gases are supplied between the third guide duct 25 and the fourth guide duct 27.

When fuel gases are discharged from between the third guide duct 25 and the fourth guide duct 27 to the outside, the fuel gases are ignited. Then, the thermal energy is generated by the combustion of the fuel gases. As described in the first embodiment, chemical reactions of the particles discharged from between the first guide duct 21 and the second guide duct 23 occur by the thermal energy generated from the combustion of the fuel gases (S40). Accordingly, new metallic or non-metallic particles are formed by using the ions, which are generated from discharge electrode 10 and discharged from the first guide duct 21, as nuclei. Naturally, the newly formed particles P are highly charged. Thus particles P are discharged to the outside under the action of the electric field, adhere to the collecting plate 70, and are colleted on the collecting plate 70 (S50).

Meanwhile, since the sheath gases are supplied between the second guide duct 23 and the third guide duct 25 as described above, the sheath gases are discharged to the ends of the second guide duct 23 and the third guide duct 25. Since the discharged sheath gases prevent the thermal energy generated through the ignition of the fuel gases from being transferred to the end of the second guide duct 23, the chemical reactions do not occur at the end of the second guide duct 23. Therefore, the chemically reacted particles do not adhere to the inner wall of the second guide duct 23, the outlet of the second guide duct 23 is not clogged. Accordingly, the reaction gases continue to be smoothly discharged.

Although the various embodiments of the present invention have been described in the above, the spirit and scope of the present invention is not limited only to the above embodiments. The specific shapes and structures shown in the above embodiments are described as only exemplified examples. In addition to the above embodiments, various modifications to the present invention may be made without departing from the spirit and scope of the claims.

### INDUSTRIAL APPLICABILITY

As described above, according the an apparatus and method for manufacturing particles using corona discharge of the present invention, collecting efficiency of the particles can be very high and sizes of the particles to be collected can be controlled.

1. An apparatus for manufacturing particles using corona discharge, comprising:
a guide duct;
a discharging means of which a discharge electrode is positioned within said guide duct, and which generate ions through electric discharge;
a reaction gas supplying means for supplying reaction gases into said guide duct;
a voltage applying means connected to said discharging means and said guide duct so as to generate voltage difference therebetween;
a heating means which is disposed on an outer surface of said guide duct for applying energy to the reaction gases so as to generate particles which are adhered to the ions generated by said discharging means;
a collecting means disposed to be spaced apart from outlet of said guide duct by a predetermined distance for collecting the particles.

2. The apparatus as claimed in claim 1, further comprising a supporting member which is fitted into said guide duct, with said discharging means held by said supporting member while passing through said supporting member, said supporting member being provided with a throughhole for allowing interior of said guide duct to communicate with outside of said guide duct.

3. The apparatus as claimed in claim 2, further comprising a reaction control gas supplying means which supplies reaction control gases through the throughhole on said supporting member to generate a lot of ions from said discharging means and to prevent chemical reaction from occurring around the discharge electrode.

4. The apparatus as claimed in claim 3, further comprising a guide electrode which is extended to interior of said guide duct while surrounding the discharge electrode for guiding laminar flow of the generated ions.

5. The apparatus as claimed in claim 3, further comprising a cooling means connected to said collecting means for cooling said collecting means.

6. The apparatus as claimed in claim 1, wherein said guide duct is constructed with a plurality of mutually connected and electrically insulated tubes so that a different level of voltage is applied to the respective tube.

7. The apparatus as claimed in claim 1, wherein the discharge electrode is formed out of a wire, and the wire is positioned between two guide plates, and reaction control gases are supplied between the guide plates.

8. The apparatus as claimed in claim 1, wherein said voltage applying means comprises a single power supply and a plurality of variable resistors.

9. An apparatus for manufacturing particles using corona discharge, comprising:
a first guide duct;
a second guide duct positioned at an outer side of said first guide duct and having an axis coaxial with said first guide duct;
a fourth guide duct positioned at an outer side of said second guide duct and having an axis coaxial with said second guide duct;
a discharging means of which discharge electrode is positioned within said first guide duct, and which generate ions through electric discharge;
a reaction control gas supplying means which supplies reaction control gases into said first guide duct to generate a lot of ions from said discharging means and to prevent chemical reaction from occurring around the discharge electrode;
a reaction gas supplying means for supplying reacting gases into said second guide duct;
a fuel gas supplying means for supplying fuel gases into said fourth guide duct;
a voltage applying means connected to said discharging means and said first guide duct so as to generate voltage difference therebetween;
a collecting means disposed to be spaced apart from outlet of said guide ducts by predetermined distance for collecting the particles of reaction gases adhered to the ions.

10. The apparatus as claimed in claim 9, further comprising a supporting member which is fitted into said first, second and fourth guide ducts, with said discharging means held by the supporting member while penetrating the supporting member, said supporting member being provided with first, second and fourth throughholes for allowing interiors of said first, second and fourth guide ducts to communicate with outside of said first, second and fourth guide ducts.

11. The apparatus as claimed in claim 10, further comprising a cooling means connected to said collecting means for cooling said collecting means.

12. The apparatus as claimed in claim 9, further comprising a third guide duct positioned between said second and fourth guide ducts for supplying sheath gas therebetween.

13. The apparatus as claimed in claim 9, wherein said voltage applying means comprises a single power supply and a plurality of variable resistors

14. An apparatus for manufacturing particles using corona discharge, comprising:
a guide duct;
a discharging means of which a discharge electrode is positioned within said guide duct, and which generate ions through electric discharge;
a reaction gas supplying means for supplying reacting gases into said guide duct;
a fuel gas supplying means for supplying fuel gases into said guide duct with the fuel gas being ignited and generating flame;
a voltage applying means connected to said discharging means and said guide duct so as to generate voltage difference therebetween;
a heating means which is disposed on an outer surface of said guide duct for applying energy to reaction gases so as to generate particles which adhered to the ions generated by said discharging means;
a collecting means disposed to be spaced apart from outlet of said guide duct by predetermined distance for collecting the particles.

15. The apparatus as claimed in claim 14, wherein the discharge electrode is formed out of a wire, and the wire is positioned between two guide plates the reaction control gas is supplied between the guide plates.

16. A method for manufacturing particles using corona discharge, comprising the steps of:
preparing an apparatus for manufacturing particles using corona discharge comprising a guide duct with a discharge electrode positioned therein, a voltage applying means connected to the discharge electrode and to the guide duct, and a collecting means for collecting the particles;
applying high voltage to the discharge electrode and applying low voltage to the guide duct, while generating ions through the discharge electrode and guiding the generated ions along the guide duct;
supplying reaction gases into the guide duct;
applying energy to the reaction gases to generate particles which are adhered to the ions;
collecting the particles adhered to the ions by the collecting means positioned in front of the guide duct.

17. The method for manufacturing particles using corona discharge as claimed 16, wherein an outer surface of the guide duct is heated to apply energy to the reaction gases.

18. The method for manufacturing particles using corona discharge as claimed 16, wherein fuel gases are supplied into the guide duct and the fuel gases are initiated to apply energy to the reaction gases.

19. The method for manufacturing particles using corona discharge as claimed 17, wherein further comprising a step of cooling the collecting means.
